(19) United States
(12) Patent Application Publication
(10) Pub. No.: US 2015/0292655 A1
(43) Pub. Date: Oct. 15, 2015

(54) Tubular Member Alignment Device

(71) Applicant: International Engine Intellectual Property Company, LLC, Lisle, IL (US)

(72) Inventor: David A. Sulka, Addison, IL (US)

(21) Appl. No.: 14/252,854

(22) Filed: Apr. 15, 2014

(51) Int. Cl. F16L 19/04; F16L 25/00; F16L 19/06

(52) U.S. Cl. CPC F16L 19/04; F16L 19/06; F16L 25/0018

(57) ABSTRACT

A device for locating and clamping tubular members such as pipes and hoses. The device is comprised of interconnected but independently controlled adjustable circumferential and longitudinal members that can be adjusted around pipes or hoses at various angles for purposes of welding or for reducing leakage respectively.

### TECHNICAL FIELD

The present disclosure pertains to tubular member alignment, particularly to a device that adjustably clamps onto and aligns two or more tubular members such as pipes or hoses relative to one another

### BACKGROUND

Connecting tubular members such as pipes in an engine test cell or other similar application is a large scale and cumbersome project. Multiple pipes have to be clamped or welded together while ensuring there are no leaks between pipe ends. Without the proper tools, this can result in a time-consuming multi-participant operation.

To achieve appropriate alignment between tubular members such as pipes, various tools have been proposed previously. In each case, the proposed devices are complex and lack the flexibility to allow for angular arrangement of tubular members and also cannot be varied to allow for the alignment of two different diameter tubular members.

A need exists for a relatively adjustable device to reduce the manpower and complexity associated with tubular member arrangements in test cells and other similar applications.

### SUMMARY

Exemplary embodiments disclosed herein provide an adjustable device that can be used to align and clamp together tubular members in such a way that a first tubular member with a first longitudinal axis is coplanar to a second tubular member with a second longitudinal axis or forms an angle with the second tubular member with the second longitudinal axis. The adjustable clamping device comprises of a first adjustable circumferential member that can be adjusted around a first tubular member and a second adjustable circumferential member that can be adjusted around a second tubular member and a first adjustable length longitudinal member, a second adjustable length longitudinal member and a third adjustable length longitudinal member that are all movably connected to each of the first and the second adjustable circumferential members. These members can be used to locate the first and the second tubular members relative to each other. According to an exemplary embodiment, the first adjustable circumferential member and the second adjustable circumferential member and the first adjustable length longitudinal member, the second adjustable length longitudinal member and the third adjustable length longitudinal member are adjusted using a worm gear mechanism. The worm gear mechanism is well known in the arts and in this application, consists of a captive screw at one end of each of the adjustable members. Each adjustable member has the corresponding notched screw thread pattern along its length. When the captive screw is turned; the captive screw pulls or pushes the notched thread pattern thereby shortening or lengthening the adjustable member respectively. Each of the adjustable members can be lengthened or shortened independent of the other adjustable members. Other embodiments for member adjustment are possible, such as using a T-bolt type mechanism, in which a bolt is attached between two ends of an adjustable member and a nut is turned to tighten or loosen the adjustable member. This mechanism is also well known in the art.

### BRIEF DESCRIPTION OF THE DRAWINGS

FIG. 1 is a perspective view of a tubular member alignment clamp;

FIG. 2 is a schematic drawing of the tubular member alignment clamp aligning co-axial pipes;

FIG. 3 is a schematic drawing of the tubular member alignment clamp demonstrating pipe alignment at an angle; and

FIG. 4 is a schematic drawing of the tubular member alignment clamp around a flexible hose

FIG. 5 is a schematic drawing of a finished complex pipe assembly welded together by using the tubular member clamp

### DETAILED DESCRIPTION

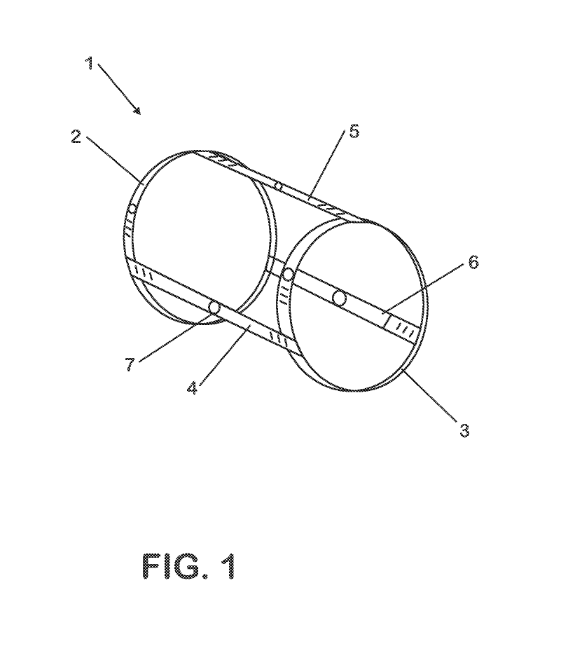

Referring now to FIG. 1, there is a tubular member alignment clamping device 1 of the present disclosure. The clamping device 1 may be attached to an end of a pipe by adjusting the adjustable circumferential member 2. In the embodiment shown in FIG. 1, the adjustable circumferential member 2 is connected to an adjustable circumferential member 3 by movably connected adjustable length longitudinal members 4, 5 and 6 respectively. More or less members than 2, 3, 4, 5 and 6 may be used depending upon requirements of a particular application. In one embodiment, each of the adjustable length longitudinal and the adjustable circumferential members 2, 3, 4, 5 and 6 is adjustable by a mechanism 7, such as a worm gear arrangement. The worm gear mechanism 7 can be controlled using a manual socket ratchet or an electronic driver. The members 2, 3, 4, 5 and 6 can be adjusted using any other suitable embodiment of the mechanism 7, such as a T- bolt arrangement. Also, each member 2, 3, 4, 5 and 6 may utilize a different embodiment of the mechanism 7. In this embodiment, each member 2,3,4,5 and 6 have one or more notches 11 to engage with the worm gear mechanism 7. The notches 11 are used to loosen or tighten each member.

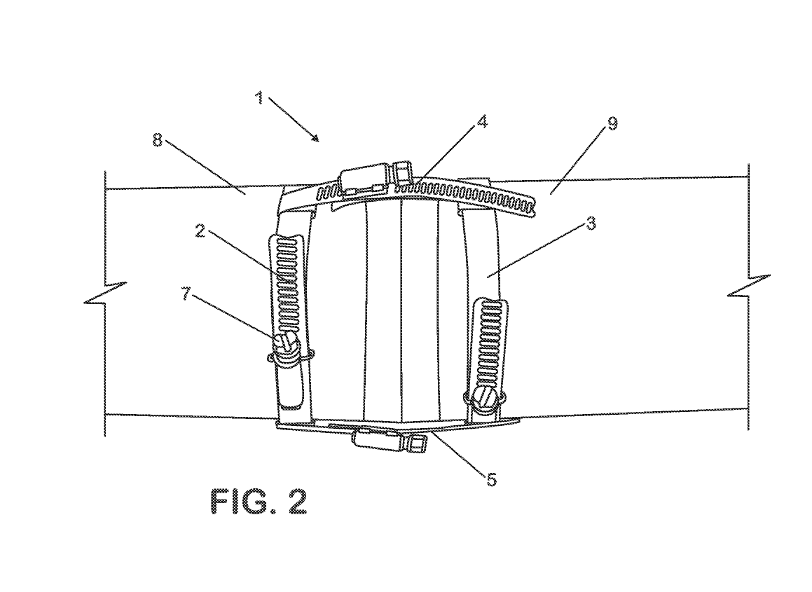

FIG. 2 demonstrates locating and aligning a first pipe 8 and a second pipe, 9 using the tubular member alignment clamping device 1. When the adjustable circumferential member 2 is adjusted, e.g. tightened or loosened in some embodiments, by using the mechanism 7 around the first pipe 8, the longitudinal axis of the second pipe 9 is aligned with the longitudinal axis of the first pipe 8 by passing the second pipe 9 through adjustable circumferential member 3. Once the desired location is accomplished, circumferential clamping member 3 is adjusted, followed by adjusting each of the three adjustable length longitudinal members 4, 5 and 6 that run along a part of the length of the first pipe 8 and second pipe 9. Each of the adjustable length longitudinal members 4, 5 and 6 are adjusted to reduce their lengths to provide even forced distribution around the first pipe 8 and the second pipe 9. The first pipe 8 and the second pipe 9 can then be welded while being held in place by the tubular member alignment clamping device 1.

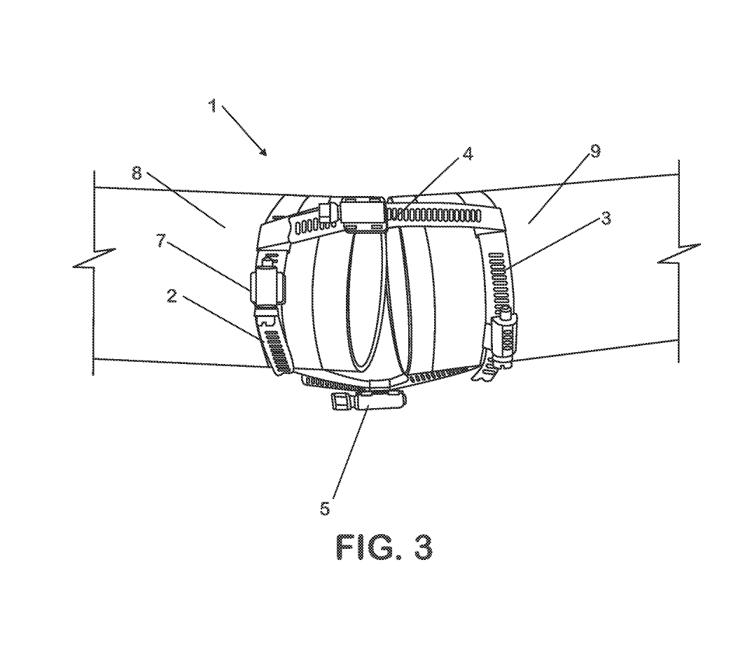

FIG. 3 demonstrates the use of the tubular member alignment clamping device 1 to align the first pipe 8 and the second pipe 9 disposed at an angle relative to each other. When the adjustable circumferential member 2 is adjusted around first pipe 8, the longitudinal axis of second pipe 9 is located at an angle with respect to the longitudinal axis of the first pipe 8 by passing the second pipe 9 through adjustable circumferential member 3. A desired angle between the longitudinal axes of first pipe 8 and the second pipe 9 is accomplished by adjusting one of adjustable length longitudinal members 4, 5, and 6 such as adjusting one adjustable length longitudinal member 4 to be shorter relative to another of the second and third adjustable length longitudinal members 5 and 6. This fixes the first and second pipes 8 and 9 at an angle relative to each other and the first pipe 8 and the second pipe 9 can be welded together in the angled position.

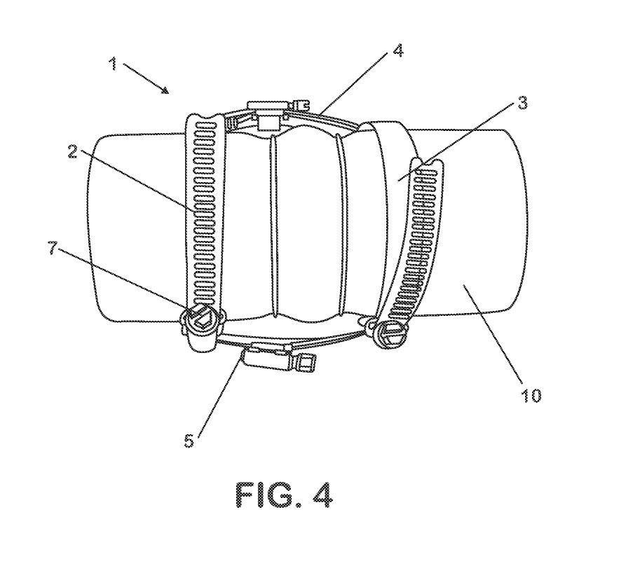

FIG. 4 demonstrates use of the tubular member alignment clamping device 1 on a flexible connecting hose 10. In this application, the tubular member alignment clamping device 1 is used to tighten the flexible connecting hose 10 by adjusting, through notches 11, both the first adjustable circumferential member 2, the second adjustable circumferential member 3, and the first, second and third adjustable length longitudinal members 4, 5 and 6 onto the flexible connecting hose 10 to reduce likelihood of a leak from an interior of the flexible connecting hose when the flexible connecting hose is placed around one or more tubular members.

The tubular member alignment clamping device 1 enables a single user to arrange tubular members in many applications, such as large scale applications in a test cell and the like, in a desired manner. Additionally, all the adjustable members of the tubular member alignment clamping device 1 can be adjusted independently of each other. The tubular member alignment clamping device 1 can be used for arranging pipes, hoses, or other similar articles, of different diameters and at different angles relative to each other.

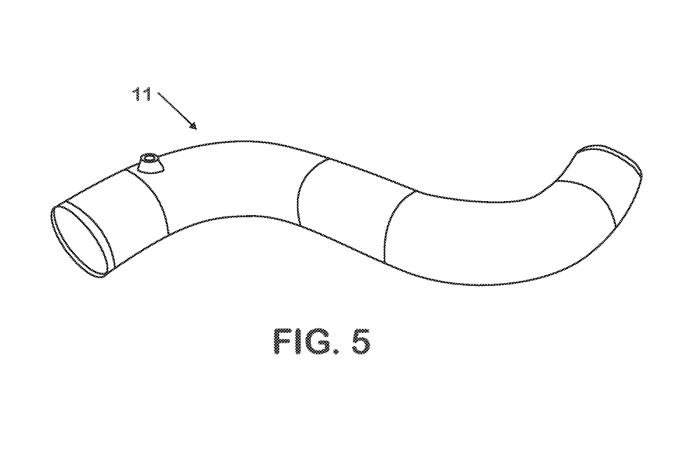

An example of a complex finished pipe assembly, 11, welded together by using the tubular member alignment clamping device 1 is shown in FIG. 5.

What is claimed is:

1. A device for locating a first tubular member having a first circumference and a second tubular member having a second circumference, comprising:
a first adjustable circumferential clamping member and a second adjustable circumferential clamping member;
a first adjustable length longitudinal member and a second adjustable length longitudinal member;
the first adjustable length longitudinal member, and the second adjustable longitudinal member being movably connected to both the first adjustable circumferential clamping member and the second adjustable circumferential clamping member;
wherein the first adjustable circumferential clamping member is adjusted around the first circumference of the first tubular member, the second adjustable circumferential clamping member is adjusted around the second circumference of the second tubular member and the first adjustable length longitudinal member and the second adjustable length longitudinal member are each adjusted to locate the first tubular member and the second tubular member with respect to each other

2. The device of claim 1, wherein at least one of the first adjustable circumferential clamping member, the second adjustable circumferential clamping member, the first adjustable length longitudinal member and the second adjustable length longitudinal member is made of stainless steel.

3. The device of claim 1, wherein at least one of the first adjustable circumferential clamping member, the second adjustable circumferential clamping member , the first adjustable length longitudinal member and the second adjustable length longitudinal member is adjusted using a mechanism located at one end of the at least one of the first adjustable circumferential clamping member, the second adjustable circumferential clamping member, the first adjustable length longitudinal member and the second adjustable length longitudinal member.

4. The mechanism of claim 3, wherein the mechanism is a worm gear arrangement.

5. The mechanism of claim 3, wherein the mechanism is a T bolt arrangement.

6. The device of claim 1, wherein a first diameter of the first adjustable circumferential clamping member and a second diameter of the second adjustable circumferential clamping member is independently adjustable

7. The device of claim 1, wherein a first length of the first adjustable length longitudinal member and a second length of the second adjustable length longitudinal member are independently adjustable

8. The device of claim 1, wherein the first adjustable length longitudinal member and the second adjustable length longitudinal member is adjustable along a first longitudinal axis of the first tubular member and a second longitudinal axis of the second tubular member.
